(19) United States
(12) Patent Application Publication
(10) Pub. No.: US 2018/0169909 A1
(43) Pub. Date: Jun. 21, 2018

(54) Method of Making a Reinforced Friction Material

(71) Applicants: Robert Bosch LLC, Broadview, IL (US); Robert Bosch GmbH, Stuttgart (DE)

(72) Inventors: Hamidreza Mohseni, Naperville, IL (US); Mark Phipps, Wayne, IL (US)

(21) Appl. No.: 15/380,843

(22) Filed: Dec. 15, 2016

(51) Int. Cl. B29C 43/00; B29C 37/00; B29C 35/02; B29C 43/36; B29C 59/02; B29C 59/14; B29C 59/16

(52) U.S. Cl. CPC B29C 43/003; B29C 37/0028; B29C 35/02; B29K 2101/10; B29C 59/02; B29C 59/14; B29C 59/16; B29C 43/36

(57) ABSTRACT

A method of making a reinforced friction material in one embodiment includes, molding a friction material composition having a predetermined pattern imparted into the molded structure. Reinforcement material is then deposited in one or more patterned areas followed by curing to produce a reinforced friction article.

### FIELD

The patent relates generally to a friction material and method of making a friction material and, more particularly, to a method of making a friction material having reinforcing materials dispersed in a predetermined pattern within the composite structure.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to systems and methods for the manufacture of reinforced friction materials is provided For example, automotive brake pads. One such method includes providing friction material and reinforcement to a mold, and molding the material under elevated temperature and pressure.

The details of one or more features, aspects, implementations, and advantages of this disclosure are set forth in the accompanying drawings, the detailed description, and the claims below.

### BRIEF DESCRIPTION OF THE DRAWINGS

FIG. 1 is a schematic view of a molded reinforced friction material, in accordance with the described embodiment.

FIG. 2 is a schematic view of a preform prior to molding, in accordance with the described embodiment.

FIG. 3 is a schematic view of a cold spray deposition process, in accordance with the described embodiment.

FIG. 4 is a schematic view of a thermal spray deposition process, in accordance with the described embodiment.

FIG. 5 is a schematic view of a punch head comprising a honeycomb pattern, in accordance with the described embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

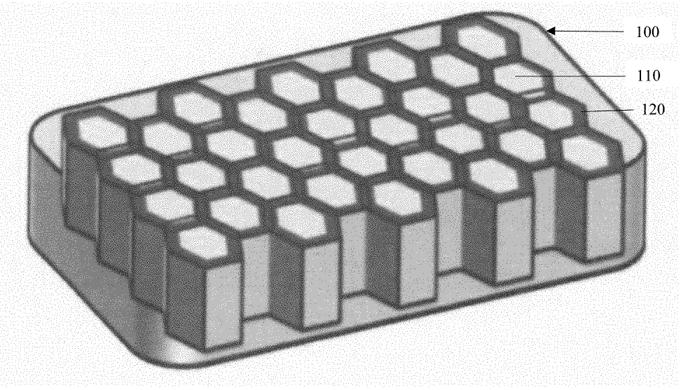

Referring to FIG. 1, there is depicted a molded reinforced friction material 100 comprising at least one region of friction material 110 and at least one region of reinforcement material 120. The molded reinforced friction material 100 comprises one or more friction materials 110 and one or more reinforcement materials 120. The one or more friction materials 110 may comprise one or more materials selected from the list consisting of fibers, fillers, binders, abrasives, and lubricants. The one or more reinforcement materials reinforcement materials 120 may comprise one or more materials selected from the list consisting of metals, alloys, composites, ceramics, and polymers.

Exemplary fibers may comprise at least one of glass, calcia, magnesia, alumina, titanium, aramid, acrylic, nylon, polybenzoxazole, polybenzimidazole, polyhydroquinone-diimidazopyridine, alumina-boria-silica, alumina-silicate, silicon nitride, silicon carbide, graphite, carbon, and peat.

In a further embodiment, the fibers optionally comprise at least one coating of interfacial materials. The at least one coating of interfacial materials can further comprise one or more layers. Exemplary interfacial materials may comprise at least one of carbon, graphite, carbide, or nitride

In a further embodiment the exemplary interfacial materials may comprise at least one of carbon, graphite, silicon nitride, silicon carbide, and boron nitride.

In a further embodiment the fibers can comprise at least one coating having a thickness of about 0.1 to about 5.0 microns.

Exemplary fillers include metal particles, metal oxide particles, barium oxide, rubber, silicate particles, calcium carbonate, barium sulfate, calcium hydroxide, vermiculite, potassium titanate and mica.

Exemplary binders may comprise at least one thermoset resin.

Exemplary thermoset resins may comprise at least one of silicon-carboxyl resins, alumina silicate resins, phenolic resins, epoxy resins, unsaturated polyester resins, vinyl ester resins, diallyl phthalate resins, and polyimide resins.

Exemplary abrasives may comprise at least one of a carbide, nitride, or oxide.

In a further embodiment the exemplary abrasives may comprise at least one of alumina, iron oxides, mullite, silica, quartz, zirconium silicate, silicon carbide, titania, silicon nitride, and boron nitride.

Exemplary lubricants may comprise at least one of graphite, coke, molybdenum disulfide, tin sulfide, zinc sulfide, antimony trisulfide, and ferric sulfide.

Exemplary metals include iron, zinc, chromium, tungsten, nickel, aluminum, platinum, molybdenum, magnesium, and titanium.

Exemplary alloys comprise at least one metal selected from the list consisting of iron, zinc, chromium, tungsten, nickel, aluminum, platinum, molybdenum, magnesium, and titanium.

Exemplary composites may comprise at least one of fiber reinforced composites and ceramic composites.

In a further embodiment the fiber reinforced composites comprise at least one of glass fiber, aramid fiber, acrylic fiber, nylon fiber, polybenzoxazole fiber, polybenzimidazole fiber, polyhydroquinone-diimidazopyridine fiber, alumina-boria-silica fiber, alumina-silicate fiber, silicon nitride fiber, silicon carbide fiber, or carbon fiber.

In various embodiments the molded reinforced friction material comprises the reinforcement material distributed upon the surface, through at least a portion of the friction material, or throughout the friction material. Additionally, the distribution can be uniform or non-uniform.

In an embodiment, the molded reinforced friction material comprises the reinforcement material in a non-uniform distribution further comprising at least one predefined shape. Exemplary shapes include honeycomb, hexagonal, pentagonal, rectangular, squares, diamond, triangular, circular, lines, zigzag, curved, oval, and elliptical.

In an embodiment, the molded reinforced friction material comprises over at least a portion of the molded reinforced friction material a non-uniform distribution of reinforcement material comprising a greater amount of reinforcement material near the surface, away from the surface, or combinations thereof

In an embodiment the composition of the at least one region of friction material may be uniform or non-uniform.

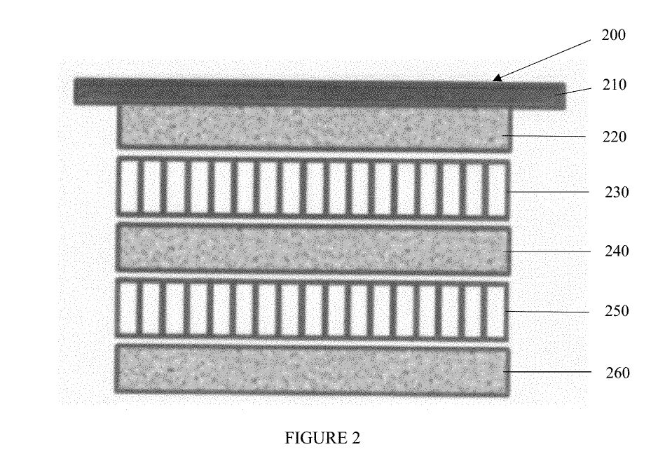

Referring to FIG. 2, there is depicted a preform structure 200 comprising a backing plate 210, friction material 220, 240, 260, and reinforcement material 230, 250. Exemplary backing plate materials can comprise at least one of metals, metal alloys and metal matrix composites (MMC) . The compositions of friction materials 220, 240, and 260 may be the same or different. The shapes, dimensions, and compositions of reinforcement materials 230 and 250 may be the same or different.

Exemplary backing plate metals may include at least one metal selected from the list consisting of iron, chromium, tungsten, nickel, zinc, aluminum, platinum, molybdenum, magnesium, and titanium.

Exemplary backing plate metal alloys may comprise at least one metal selected from the list consisting of iron, chromium, tungsten, nickel, zinc, aluminum, platinum, molybdenum, magnesium, and titanium.

In some embodiments the molded reinforced friction material can be produced by various hot pressing techniques. For example friction material and reinforcement material can be placed in a mold and subjected to elevated heat and pressure to produce a molded article. Further examples of hot pressing techniques include positive molding, and flash molding.

In various embodiments the performance of the molded reinforced friction material can be tailored to specific needs by controlling the selection and distribution of the friction materials and reinforcement materials. For example friction and wear performance, resistance to fade, recovery time, noise minimization, vibration minimization, and minimization of damage to the counterface, can be tailored for a variety of service conditions.

In an embodiment the distribution of reinforcement materials in the resulting molded reinforced friction material can be tailored by directly inserting one or more preform reinforcement materials into the mold prior to molding. The preforms can be positioned in the mold relative to the friction material to provide reinforcement at desired locations within the resulting composite structure. For example, FIG. 2 depicts a plurality of layers of friction material and a plurality of layers of reinforcement material prior to molding. The friction materials and reinforcement materials may comprise material components as described above.

In an embodiment the distribution of reinforcement materials in the resulting molded reinforced friction material can be tailored as desired by forming a molded friction material having a patterned structure and subsequently depositing reinforcing material at desired locations of the patterned structure.

In some embodiments at least one pattern can be provided to the friction material during the molding process. Techniques for providing a pattern during the molding process may comprise providing a surface to the inside of the mold having at least one predetermined pattern. During molding the pattern can be imprinted into the friction material. One or more additional materials, such as reinforcing materials, may be subsequently deposited at one or more desired locations of the patterned structure.

In some embodiments at least one pattern may be provided to the molded friction material after removal from the mold. Techniques for providing a pattern to the molded friction material may comprise one or more of laser ablation, chemical etching, plasma etching, scoring, and embossing.

In various embodiments the depth of the pattern may be controlled to provide reinforcement material in a desired profile. For example, if it is desired to provide reinforcement material to a thin material or near the surface of a thicker material, one or more patterns may be provided having a shallow depth, such as about 0.5 millimeters, about 1.0 millimeter, or about 2.0 millimeters. If it is desired to provide reinforcement material to a greater depth or through the entire thickness dimension of the friction material one or more patterns having a greater depth, such as about 5.0 millimeters, about 10.0 millimeters, about 15.0 millimeters, about 20.0 millimeters, or even greater than about 30.0 millimeters can be provided. Combinations of patterns having combinations of depths can be provided to provide the desired characteristics of the friction article.

Various techniques can be used to deposit at least one reinforcing material at desired locations depending on the form of the reinforcing material. The reinforcing material may be deposited in solid form, for example, as particles and powders, liquid form, for example, as liquids and solutions, gaseous form, for example, as vapors. Combinations of reinforcing materials having different forms may be suitably deposited by suitable selection of deposition techniques.

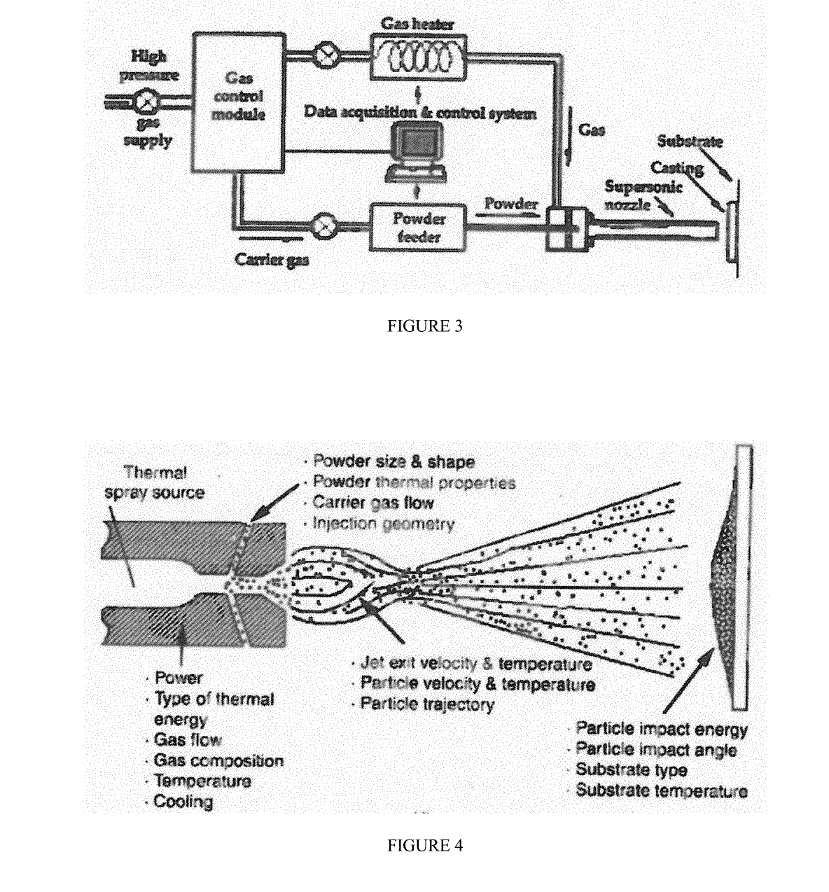

In some embodiments the reinforcing material may comprise powders or particles. For example, for heat tolerant substrates, techniques for the deposition of powders or particles may comprise thermal deposition techniques. Exemplary thermal deposition techniques, for example, include thermal spraying and plasma spraying. For substrates having a lower heat tolerance, techniques such as cold spray deposition may be suitable. FIG. 3 and FIG. 4 provide depictions of one type of cold spray system and one type of thermal spray system, respectively.

In some embodiments the reinforcing material may comprise liquids or solutions. For example, techniques for the deposition of liquids or solutions may comprise one or more of deposition followed by solvent removal, for example by evaporation, deposition followed by polymerization, for example curing (i.e. cross-linking), and deposition followed by chemical bonding, for example, bonding with at least one component of the friction material.

In some embodiments the reinforcing material may comprise vapors. For example, techniques for the deposition of vapors may comprise, vapor deposition polymerization such as by, initiated chemical vapor deposition or oxidative chemical vapor deposition. These vapor deposition techniques allow for the controlled fabrication of high molecular weight polymer films and can be used to modify the surfaces of three-dimensional curved, pillared, and porous substrates without solvent effects such as clogging or wetting.

In some embodiments prior to deposition of the reinforcement material upon the patterned friction material one or more masks may optionally be employed to shield one or more regions of the patterned friction material from contact with reinforcement material. While the addition of one or more masks may result in at least one additional processing step, the use of one or more masks may also allow the deposition of reinforcement materials to simultaneously be carried out over a greater portion of the patterned friction material.

In various embodiments, the reinforced patterned friction material may be subjected to at least one additional consolidation treatment. For example, the reinforced patterned friction material may be heated at elevated temperature in an open-air oven. In some further embodiments the additional consolidation treatment may result in the curing of one or more constituent materials of the friction material composite.

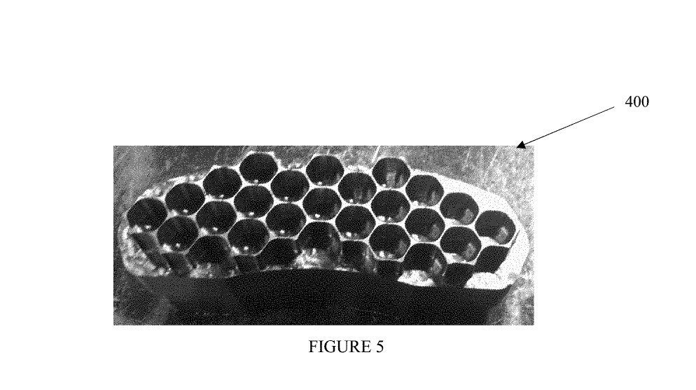

In various embodiments, the reinforced patterned friction material may be subjected to additional post molding processing. The additional post molding process may comprise one or more of grinding, cutting, scorching or coating. For example, an environmental coating or sealant may be provided to the surface of the friction material to protect the molded article. FIG. 5 illustrated an exemplary punch head 400. The head 400 comprises comprising a plurality of honeycomb pattern for forming a molded reinforced friction material 100 as illustrated in FIG. 1. The head 400 may be formed for any suitable materials.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

It is believed that the patent and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method of making a reinforced friction material comprising:
a) forming a molding composition comprising at least one friction material and at least one reinforcement material;
wherein, the friction material comprises at least one material selected from list consisting of fibers, fillers, binders, abrasives, and lubricants;
wherein, the reinforcement material comprises at least one material selected from the list consisting of metals, alloys, composites, ceramics, and polymers; and
wherein, the reinforcement material comprises at least one predetermined shape;
b) molding the molding composition into a molded article
c) curing the molded article.

2. The method of claim 1:
further comprising,
grinding, cutting, scorching or coating the molded article.

3. The method of claim 1:
wherein, the reinforcement material comprises at least one open cell cellular material which further comprises the predetermined shape.

4. The method of claim 3:
wherein, the predetermined shape comprises honeycomb, hexagonal, pentagonal, rectangular, squares, diamond, triangular, circular, lines, zigzag, curved, oval, or elliptical; and
wherein, the open cell cellular material further comprises at least one material comprising at least one of iron, zinc, chromium, tungsten, nickel, aluminum, platinum, molybdenum, magnesium, and titanium.

5. The method of claim 1:
wherein, the friction material comprises at least one binder; and
wherein, the at least one binder comprises at least one thermoset resin.

6. The method of claim 5:
wherein, the at least one thermoset resin comprises at least one resin selected from the list consisting of silicon-carboxyl resins, alumina silicate resins, phenolic resins, epoxy resins, unsaturated polyester resins, vinyl ester resins, diallyl phthalate resins, and polyimide resins.

7. The method of claim 5:
wherein, the friction material additionally comprises at least one filler; and
wherein, the at least one filler comprises at least one material selected from the list consisting of metal particles, metal oxide particles, barium oxide, rubber, silicate particles, calcium carbonate, barium sulfate, calcium hydroxide, vermiculite, potassium titanate and mica.

8. The method of claim 5:
wherein, the friction material additionally comprises at least one fiber; and
wherein, the at least one fiber comprises at least one material comprising at least one material selected from the list consisting of glass, calcia, magnesia, alumina, titanium, aramid, acrylic, nylon, polybenzoxazole, polybenzimidazole, polyhydroquinone-diimidazopyridine, alumina-boria-silica, alumina-silicate, silicon nitride, silicon carbide, graphite, carbon, and peat.

9. A method of making a reinforced friction material, comprising:
forming a molding composition comprising at least one friction material wherein the friction material comprises at least one material selected from list consisting of fibers, fillers, binders, abrasives, and lubricants;
molding the molding composition into a molded article comprising a patterned surface using a mold;
separating the molded article from the mold;
depositing reinforcement material; and
curing the molded article with the deposited reinforcement material present to form the reinforced friction material.

10. The method of claim 9 wherein the mold comprises at least one depression or extension configured to form the patterned surface.

11. The method of claim 10 wherein the mold comprises at least one punch comprising the at least one depression or extension.

12. The method of claim 9 further comprising,
masking a portion of the patterned surface prior to depositing the reinforcement material.

13. The method of claim 9 wherein depositing reinforcement material comprises at least one of thermal spraying reinforcement material, plasma spraying reinforcement material, cold spray deposition of reinforcement material, solution deposition of reinforcement material, and vapor deposition of reinforcement material.

14. The method of claim 9 wherein the reinforcement material is deposited on the patterned surface.

15. The method of claim 9, wherein;
the friction material comprises at least one binder; and
the at least one binder comprises at least one thermoset resin.

16. The method of claim 15 wherein the at least one thermoset resin comprises at least one resin selected from the list consisting of silicon-carboxyl resins, alumina silicate resins, phenolic resins, epoxy resins, unsaturated polyester resins, vinyl ester resins, diallyl phthalate resins, and polyimide resins.

17. The method of claim 16, wherein;
the friction material additionally comprises at least one filler; and
the at least one filler comprises at least one material selected from the list consisting of metal particles, metal oxide particles, barium oxide, rubber, silicate particles, calcium carbonate, barium sulfate, calcium hydroxide, vermiculite, and mica.

18. The method of claim 15, wherein;
the friction material additionally comprises at least one fiber; and
the at least one fiber comprises at least one material selected from the list consisting of glass, alumina, titanium, aramid, acrylic, nylon, polybenzoxazole, polybenzimidazole, polyhydroquinone-diimidazopyridine, alumina-boria-silica, alumina-silicate, silicon nitride, silicon carbide, graphite, carbon, and peat.

19. The method of claim 9, wherein the predetermined shape comprises a cellular shape.

20. The method of claim 19, wherein;
the cellular shape comprises a honeycomb shape, hexagonal, a pentagonal shape, a rectangular shape, a square shape, a diamond shape, a triangular shape, a circular shape, a curved shape, an oval shape, or an elliptical shape; and
the reinforcement material further comprises at least one material comprising at least one of iron, zinc, chromium, tungsten, nickel, aluminum, platinum, molybdenum, magnesium, and titanium.

21. The method of claim 9, further comprising:
grinding, cutting, scorching or coating the molded article.

22. A method of making a reinforced friction material comprising:
a) forming a molding composition comprising at least one friction material;
wherein, the friction material comprises at least one material selected from list consisting of fibers, fillers, binders, abrasives, and lubricants;
b) molding the molding composition into a molded article;
c) imparting at least one patterned region upon at least a portion of the molded article;
d) depositing reinforcement material upon at least a portion of the patterned region;
e) curing the molded article.

23. The method of claim 22:
further comprising,
c1) masking a portion of the patterned surface.

24. The method of claim 22:
wherein, imparting a patterned surface comprises at least one of laser ablation, chemical etching, plasma etching, scoring, and embossing.

25. The method of claim 22:
wherein, the friction material comprises at least one binder; and
wherein, the at least one binder comprises at least one thermoset resin.

26. The method of claim 25:
wherein, the at least one thermoset resin comprises at least one resin selected from the list consisting of silicon-carboxyl resins, alumina silicate resins, phenolic resins, epoxy resins, unsaturated polyester resins, vinyl ester resins, diallyl phthalate resins, and polyimide resins.

27. The method of claim 25:
wherein, the friction material additionally comprises at least one filler; and
wherein, the at least one filler comprises at least one material selected from the list consisting of metal particles, metal oxide particles, barium oxide, rubber, silicate particles, calcium carbonate, barium sulfate, calcium hydroxide, vermiculite, and mica.

28. The method of claim 25:
wherein, the friction material additionally comprises at least one fiber; and
wherein, the at least one fiber comprises at least one material selected from the list consisting of glass, alumina, titanium, aramid, acrylic, nylon, polybenzoxazole, polybenzimidazole, polyhydroquinone-diimidazopyridine, alumina-boria-silica, alumina-silicate, silicon nitride, silicon carbide, graphite, carbon, and peat.

29. The method of claim 22:
wherein, the depositing of reinforcement material comprises at least one of thermal spraying, plasma spraying, cold spray deposition, solution deposition, and vapor deposition.

30. The method of claim 22:
wherein, the reinforcement material is deposited on at least one patterned region.

31. The method of claim 22:
wherein, the patterned region comprises at least one of a honeycomb, hexagonal, pentagonal, rectangular, squares, diamond, triangular, circular, curved, oval, or elliptical region; and
wherein, the reinforcement material further comprises at least one material comprising at least one of iron, zinc, chromium, tungsten, nickel, aluminum, platinum, molybdenum, magnesium, and titanium.
